(19) United States
(12) Patent Application Publication
(10) Pub. No.: US 2005/0028748 A1
(43) Pub. Date: Feb. 10, 2005

(54) Feces-conveying installation for breeding units and method for operating such an installation

(76) Inventor: Josef Kuhlmann, Laer (DE)

Correspondence Address: MERCHANT & GOULD PC, P.O. BOX 2903, MINNEAPOLIS, MN, 55402-0903, US

(21) Appl. No.: 10/487,108

(22) PCT Filed: Jul. 26, 2003
(86) PCT No.: PCT/DE03/02529

(51) Int. Cl. A01K 1/01

(52) U.S. Cl. 119/451

(57) ABSTRACT

The invention relates to a manure transport device for livestock breeding operations, consisting of a circulating, driven manure conveyor belt arranged underneath a stall floor, which belt has at least one drive roller and at least one driven return roller. The return roller is arranged with its drive unit in a floating manner and an adjustment device acting upon the drive unit intermittently causes a tensioning of the manure conveyor belt.

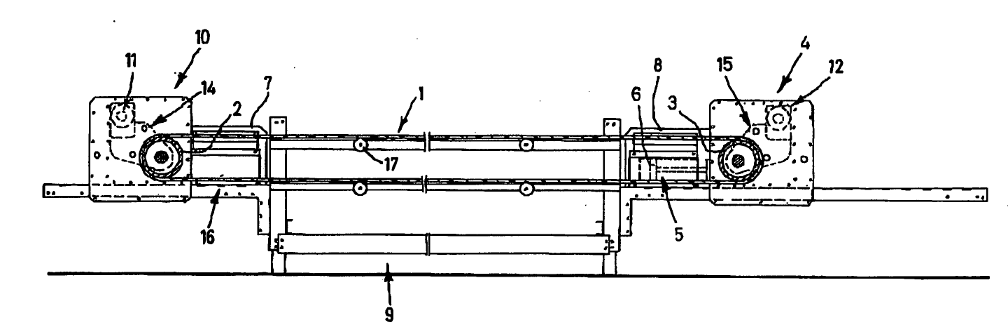

The invention relates to a manure transport device for livestock breeding operations according to the precharacterizing part of claim 1 and a method for operating a manure transport device according to the precharacterizing part of claim 6.

Manure transport devices for livestock breeding operations, which devices have a driven, circulating manure conveyor belt arranged underneath a cage floor and have at least one driven drive roller and at least one driven return roller, are known, for example, from DE 195 14 574 C1. This known device is suitable for poultry breeding operations in which poultry drop a relatively solid but moist manure.

In the device according to DE 195 14 574 C1 the trouble arises that planar textile structures can be used as conveyor belts only with great difficulty, as they always have the tendency to slip from the drive and return rollers due to the fact that the textile structure does not allow a trouble-free guiding of the belt. In this known device, the straight course of the belt has been ensured through the fact that the return roller has a higher rotational speed than the drive roller, experiments having shown that this arrangement makes possible a trouble-free guiding of the manure conveyor belt.

Described in DE 10 96 669 B is a watering-place manure removal device in which, underneath the grating forming the stand for the stall animals, is formed an oblique plane preferably covered by plastic plates, on which plane can glide pushers that can be moved over the oblique plane by a motor by the aid of a chain and roller drive. In order to keep the conveyor arrangement for these manure pushers continuously tensioned, assigned to one of the two rotating shafts, in particular that for the non-driven roller, is a tensioning device in the form of a spring, which acts upon the bearing of the rotating shaft. Although here the return roller is supported in a floating manner, it is not a driven roller in this case.

In livestock breeding installations in which animals are kept that drop the solid manure and liquid urine, there arises considerable difficulty in carrying away this very moist, mushy mixture. For example, known from DE 35 28 604 A1 is a manure removal arrangement for small-animal farms, which arrangement has a two-part design, namely, consisting on the one hand of a liquid-tight bottom part that serve as a urine collection trough, a fall-through grating being arranged above this liquid-tight bottom trough. This fall-through grating is formed by a conveyor assembly or conveyor belt, which does not display in a circulating manner an upper and lower belt half, but rather consists of a single layer of a moisture-permeable material, which layer can, for example, be a lattice-like textile.

The use of such an arrangement in the case in swine breeding operations would not be successful, because the solid manure involved here is still relatively soft and would fall through the fall-through grating.

If conveyor belts are used in swine breeding operations for the removal of the manure, a very quick fouling of the underlying return roller occurs, so that the conveyor belt slips off laterally. Likewise, the attempt to design the drive and/or return rollers in a convex manner in order to achieve a straight course of the conveyor belt has not been successful, because the fouling is so great and the solid manure components equalize the convexity of the return and drive rollers.

Also, the attempt to design the return and/or drive rollers as latticed rollers in order to achieve an appropriate guidance has proved a failure, since these rollers inside the lattice then become clogged extraordinarily quickly.

The invention is based on the task of creating a manure transport device for livestock breeding operations in which any conveyor belt can be used, that is to say, a closed belt or a webbed, open belt, and in which the straight course of the belt is ensured in spite of the considerable fouling of the underside of the belt and of the drive and return rollers.

This task forming the basis of the invention is accomplished through the teaching of claim 1 and the teaching of claim 6.

Advantageous embodiments are explained in the dependent claims.

Expressed in other words, it is proposed that the drive unit receiving the return roller be supported in a floating, i.e. adjustable manner and that the drive unit of the return roller and thus the return roller itself be equipped with an adjustment device that ensures the tensioning of the actual manure conveyor belt.

With such an arrangement, the following manner of operation is possible:

The drive unit of the return roller is driven in the same rotational direction as the drive unit of the drive roller. This is the normal operating state of the manure conveyor belt, i.e. the belt is tensioned and driven by both rollers in a single direction in a circulating manner. If now the belt tension is relaxed through the adjusting device and through shifting of the drive unit for the return roller, then the return roller and the drive roller can freely rotate and, at the same time, the belt has the possibility of returning again to a straight course if it has in fact drifted out of a straight course. Achieved simultaneously is the fact that, through the relaxing of the belt and through the free rotating of both the drive roller and the return roller, these rollers can free themselves from the dung that has accumulated on them.

In a further possibility regarding the manner of operation, when the adjustment device cancels the belt tension, simultaneously the return roller is driven counter to its normal rotational direction. Achieved through this is that the belt is led back to a straight course, and here also a better throwing off or cleansing of the manure fixed to the return roller and the drive roller is effected.

In a third manner of operation there exists the possibility of driving the return roller counter to its normal rotational direction even though the belt is tensioned, i.e. the adjustment device is acting on the return roller with pressure. In such a case, the belt stands still, the rollers clean themselves through the effective idling under the belt and, at the same time, a returning of the belt to a straight course is effected.

The actual adjustment device is preferably a hydraulic or pneumatic piston/cylinder arrangement that can be activated in a pulsed manner.

The time period during which the adjustment device is activated amounts to perhaps only a few seconds, this period being sufficient to effect a resetting of the manure conveyor belt and, simultaneously, to ensure thereby the cleaning of the return and the drive roller.

According to a further embodiment of the invention, both in the region of the drive roller and in the region of the return roller are arranged guide shields on both sides of the manure conveyor belt, which shields prevent the manure conveyor belt from running too far out of line. These guide shields, even when the belt has run out laterally, produce a certain tensioning or a certain resetting pressure that is effective when the adjustment device has canceled the belt tensioning, and, regardless of the rotational direction in which the return roller is now driven, a very quick resetting of the manure conveyor belt is effected.

According to a further embodiment of the invention, the manure conveyor belt is arranged with the drive unit on a support frame, with at least the drive unit being fixedly mounted in a grid bearing of the support frame, so that adaptations to the different belt lengths and thus different cage sizes are thereby possible.

The invention relates, finally, to a method for operating a manure transport device for livestock breeding operations in which is used a circulating manure conveyor belt having at least one drive roller and one driven return roller. Here, the tensioning of the return roller is relaxed in a pulsed manner, which is achievable through the fact that the actual drive unit for the return roller is supported in a floating manner and can be acted on by an adjustment device that produces the belt tension.

In the method according to the invention, the adjustment device is activated in a pulsed manner, so that the belt tension is canceled. Achieved thereby, regardless of the rotational direction in which the return roller is driven, is the possibility of returning the belt to a straight course again, which is assisted by the guide shields arranged at the sides of the belt.

In the following, an embodiment example of the invention is explained with reference to the drawing.

Shown schematically in the drawing is a manure transport device that has a manure conveyor belt 1 that is led over a drive roller 2 of a drive unit 10. The drive unit 10 displays a drive motor 11 as well as a corresponding transmission 14, and this drive unit is supported on a support frame 9 via a grid bearing 16. This drive unit 10 can thus be adjusted to match the desired belt length and the desired stall size.

The actual manure conveyor belt 1 is guided via support rollers 17 and displays a return roller 3 arranged opposite the drive roller 2. This return roller 3 is arranged in a drive unit 4 that possesses a transmission 15 and a motor 12, this drive unit 4 being supported in a floating manner, i.e. it can shift in relation to the drive unit 10. Via an adjustment device 5, which is preferably implemented as a piston/cylinder arrangement 6, the drive unit 4 is placed under pressure and thus the belt tensioning is achieved.

The drive unit 10, with motor 11 and transmission 14, is always driven in one direction and the drive unit 4 is also normally driven in that same direction, so that both rollers, i.e. the drive roller 2 and the return roller 3 have the same direction of rotation. If now the adjustment device 5 is activated, i.e. the pressure from this adjustment device 5 is canceled, then the return roller 3 theoretically runs freely, the manure conveyor belt 1 sags, and now the manure conveyor belt shifts back to a straight course. Simultaneously, the manure accumulating on the drive roller 2 and the return roller 3 is scraped off and these two rollers are thereby cleaned. The operation of the adjustment device 5 can take place in a pulsed manner.

It is further possible, when the adjustment device is activated, to simultaneously drive the return roller 3 with its drive unit reversed, i.e. counter to the rotational direction of the drive roller 2. Thus, in this arrangement there occurs a sagging of the manure conveyor belt 1, a returning of the manure conveyor belt 1 to a straight course, and finally a cleaning of the actual rollers 2 and 3. Moreover, through the reversed manner of operation of the return roller 3 a preferable resetting of the manure conveyor belt 1 is achieved.

As the third possibility, the return roller 3 can be activated in a pulsed manner while the belt tensioning is maintained. In such a case the manure conveyor belt 1 stands still, but the rollers revolve, thereby resulting in a cleaning of the rollers as well as a returning of the manure conveyor belt 1 to a straight course.

As soon as the pulse time span is expired, the piston/cylinder arrangement 6 is again placed in operation, the belt is tensioned, and simultaneously the drive for the return roller 3 is stopped, i.e. the return roller 3 idles.

In this, the control of the drive unit 4 is designed such that during the normal operating time of the drive of the return roller 3, the return roller 3 is driven in the same direction as the drive roller 2.

On both sides of the conveyor belt, in the inlet region of the drive unit 10 and the drive unit 4, are arranged so-called guide shields 7 and 8, which border on the side edges of the manure conveyor belt 1. When the belt runs out of line, the belt edges run against these guide shields 7 and 8 and are compressed here. If now the belt tensioning is relaxed through the adjustment device 5, the manure conveyor belt 1 is reset again, with these guide shields 7 and 8 and the belt edges running against the guide shields 7 and 8 assisting this resetting of the belt 1.

In the drawing, the support for the drive unit 4 is also shown as a grid bearing 16. Achieved thereby is a simplified structure of the collective arrangement, since for both sides of the belt the same components can be used.

The adjustment device 5 has a dual design, i.e. on each side, laterally to the manure conveyor belt 2, a corresponding adjustment device 5 is effective, so that when this adjustment device is activated the return roller 3 is precisely aligned and is not stressed more on one side than on the other.

1. Manure transport device for livestock breeding operations consisting of a circulating, driven manure conveyor belt (1) arranged underneath a stall floor, which belt has at least one drive roller (2) and at least one driven return roller (3), wherein
a) the return roller (3) is arranged with its drive unit (4) in a floating manner, and
b) an adjustment device (5) acting on the drive unit (4) effects a tensioning of the manure conveyor belt (1) in an intermittent manner.

2. Manure transport device as claimed in claim 1, wherein the adjustment device (5) is formed as a hydraulic or pneumatic piston/cylinder arrangement (6).

3. Manure transport device as claimed in claim 1, wherein guide shields (7, 8) are arranged in the region of the drive roller (2) and the return roller (3) on both sides of the manure conveyor belt (1).

4. Manure transport device as claimed in claim 1, wherein
a) the rotational movement of the return roller (3) of the drive unit (4) can be impelled in the direction opposite to that of the rotational movement of the drive roller (2) of the drive unit (10), and
b) the adjustment device (5) and the drive unit (4) can be operated at intervals.

5. Manure transport device as claimed in claim 1, wherein the manure conveyor belt (1) is arranged with the drive units (10, 4) on a support frame (9).

6. Method for operating a manure transport device for livestock breeding operations with a manure conveyor belt arranged underneath a stall floor and being driven in a circulating manner, which conveyor belt has at least one driven drive roller and at least one driven return roller, wherein the return roller can be shifted in the longitudinal axis of the manure conveyor belt and is acted upon by an adjustment device through which a tensioning of the manure conveyor belt is regulated, the adjustment device producing the tension on the manure conveyor belt being intermittently active.

7. Method as claimed in claim 6, wherein the return roller is driven in the direction opposite to that of the drive roller and the adjustment device producing the tension on the manure conveyor belt is intermittently switched on at the same point in time.

8. Method as claimed in claim 6, wherein the return roller is driven in the direction opposite to that of the drive roller, but the adjustment device continues to maintain the belt tensioning.
